(19) United States
(12) Patent Application Publication
(10) Pub. No.: US 2005/0033598 A1
(43) Pub. Date: Feb. 10, 2005

(54) System and method for documenting critical tasks in complex work environment

(75) Inventors: Jonathan E. Knapp, Houston, TX (US); Mitchell S. Fralick, Houston, TX (US); Stephen A. Kobb, Houston, TX (US)

Correspondence Address: THOMPSON & THOMPSON, P.A., P.O BOX 166, SCANDIA, KS, 66966, US

(73) Assignee: Producers Assistance Corporation

(21) Appl. No.: 10/892,715

(22) Filed: Jul. 15, 2004

Related U.S. Application Data
(60) Provisional application No. 60/487,821, filed on Jul. 15, 2003.

(51) Int. Cl. G06F 17/60

(52) U.S. Cl. 705/1

(57) ABSTRACT

A system and method for documenting critical tasks in a complex work environment using a computer to track the critical tasks from assignment to completion. The flow of accountability is tracked from the assignment of critical tasks to the completion and reporting of the performance of the tasks. The system creates a probe containing a set of mutually exclusive statements pertaining to a critical task, transmits the probe to field personnel, receives an input from the field personnel corresponding to a selected one of the mutually exclusive statements, and saves the input as a permanent transcript. The system reviews the transcript to determine whether certain alert codes are present, and then triggers predefined actions based on the presence of the alert codes. The system alerts other team members when expectations are not met, either because a scheduled input is not received, or because a condition is detected requiring management attention.

### RELATED APPLICATIONS

This application claims the benefit of the Applicants' provisional patent Application No. 60/487,821 filed on Jul. 15, 2003.

### BACKGROUND OF THE INVENTION

1. Field of the Invention

The present invention relates generally to systems and methods used to track the performance of certain tasks that are critical to the operation of facilities or processes. In particular, the present invention relates to a system and method for tracking and documenting critical tasks in a complex work environment.

2. Description of the Related Art

Probably the most widely used management tool associated with autonomous maintenance implementation is the checklist. Of course, some equipment manufacturers supply maintenance checklists with their machines, but comprehensive checklists can be readily developed in-house for use by machine operators. The timing, frequency, and level of detail of the checklists may be modified to fit local conditions.

The checklists may include instructions as to what the operator is to do if certain items are found to be outside the limits or tolerances expressed in the checklists. These instructions may require the operator to simply log the problem. In severe cases, the checklist may require that the operator immediately shut down the equipment and notify someone in upper management.

In the case of production operations, checklists may be developed that set parameters for all observable activities within the facility such as proper product handling, testing, and shipment. Checklists may be developed that prompt plant personnel to check for tolerances, weights, counts, time from initiation of production to shipment, and so forth. Even machine down time can be reported via the checklist method.

Facility managers must be aware of the condition of the facility support systems such as ventilation, cooling water for equipment, building structural integrity, and the general environment both within the plant and on the surrounding property. Checklists can be developed that require someone check certain items on a scheduled basis and report their findings to facility supervisors for action.

Human nature being what it is, repetitive tasks can be seen as monotonous and unimportant to many. Workers ask why they have to do the same thing over and over the same way day after day. Workers may get complacent or they may get in a hurry and dismiss routine checklists as unimportant or unnecessary.

Of course, management knows that historical data cannot be relied upon if it is not gathered in a timely and repetitive manner with all the variables under tight control. Often the only way that data gathering activities are policed is by overt observation or spot checks. Either method may be construed by the work force as management being distrustful of labor.

Some analysts and engineers believe the only answer is to automate the entire monitoring and data collection process. They advocate placing monitors, counters, samplers, scales, etc. at all data collection points with the electronically collected data routed into a central computer for analysis. But, not all conditions can be monitored with automated systems. Sooner or later, a knowledgeable human must be incorporated into the process of information acquisition and evaluation.

In today's competitive environment, the need to not only be aware of conditions but to effectively manage them is paramount. Condition management has two key aspects: Management must be assured that front-line personnel are actually monitoring the condition in question. Monitoring here means that someone must focus attention on a system or situation, and then bring its condition into conscious awareness. As mentioned previously, this is easier said than done. The frequently repetitive nature of condition monitoring often leads to routine responses rather than critical analysis.

Information must be moved from the point of acquisition to the point of decision. The organization does not benefit when field or plant floor personnel are the only ones who know of a system's condition. even when that condition is optimal. The observed fact that “All is Well” does not eliminate management's need to record the observation for historical and analytical purposes. In short, monitoring data must be transferred to decision-markers on a routine basis, regardless of content. Of course, if the report indicates a sub-optimal situation, that information needs to be distributed ASAP to other members of the team who can make decisions and take corrective action.

Organizations need an economical and reliable way to track the performance of these various tasks that are critical to the operation of facilities or processes. As mentioned above, such tracking is often done by a combination of paper and electronic forms, inspection software, phone calls, meetings, fax, E-mail, and pagers. However, these methods suffer from several disadvantages, including the following: insufficient control of risk factors; mandate for action often lacking in existing methods; remote systems are difficult to manage; repetitive action breeds indifference to critical tasks; operational expectations are often undefined; speed of communication is lacking; timely scheduling of events is difficult; dishonesty in reporting often occurs; established procedures are not followed or are not fully developed; completions of critical tasks are not adequately documented; and reporting hierarchy impedes rapid and thorough communication.

There is a need in many organizations for an improved system and method for documenting critical tasks and improving accountability to overcome these and other problems associated with the prior art.

### SUMMARY OF THE INVENTION

An object of the present invention is to provide an improved system and method for documenting and tracking the performance of critical tasks in the operation of facilities or processes.

A further object of the present invention is to provide a system and method for coordinating actions and expectations in a complex work environment.

A further object of the present invention is to provide a system and method for reducing risk in a complex work environment by facilitating social interdependence using computer-aided accountability.

A further object of the present invention is to provide a system and method for managing a complex work environment that provides local decision-makers with an unprecedented ability to take action.

To achieve the foregoing and other objects and in accordance with the purpose of the present invention, as embodied and broadly described herein, the present invention provides a system and method for tracking and documenting critical tasks in a complex work environment from assignment to completion using a computer. The invention tracks the flow of accountability from one person to the next every step of the way, from the assignment of critical tasks, to the completion and reporting of the performance of the critical tasks. This saves the organizational users of the invention time, expenses, headaches, crises, and so forth because if somebody “drops the ball,” the superiors know about it right away. The invention uses a computer system to make sure that every person playing a role in the assignment and performance of a critical task knows what that role is, what is expected of him or her, and when they have to produce a work product. If the critical task is not performed or if a suboptimal condition is reported, the computer automatically tracks that, notifies the relevant parties, and creates a permanent record of the same.

According to a broad aspect of the present invention, a method of documenting critical tasks in a complex work environment is provided, comprising the steps of: creating a probe containing a set of mutually exclusive statements pertaining to a critical task; transmitting the probe to field personnel; receiving an input from field personnel corresponding to a selected one of the mutually exclusive statements; and saving the input as a transcript that becomes part of a permanent record.

According to another broad aspect of the present invention, a computer software program is provided for documenting critical tasks in a complex work environment, comprising: means for creating a probe containing a set of mutually exclusive statements pertaining to a critical task; means for transmitting the probe to field personnel; means for receiving an input from field personnel corresponding to a selected one of the mutually exclusive statements; and means for saving the input as a transcript that becomes part of a permanent record.

According to another broad aspect of the present invention, a system for documenting critical tasks in a complex work environment is provided, comprising: an input device for inputting design parameters of a probe for obtaining information about a critical task; a computer that communicates with the input device and has a software program as described in the preceding paragraph; and a communications device for use by field personnel to receive the probe and to communicate information input by the field personnel back to the computer responsive to the probe.

Numerous other objects of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a flow chart of a series of method steps for tracking and documenting critical tasks in a complex work environment according to the present invention.

FIG. 2 is a more detailed view of a flow chart for tracking and documenting critical tasks according to the present invention.

FIG. 3 is a diagrammatic view of a system for tracking and documenting critical tasks according to the present invention.

### DETAILED DESCRIPTION OF THE PREFERRED EMBODIMENT

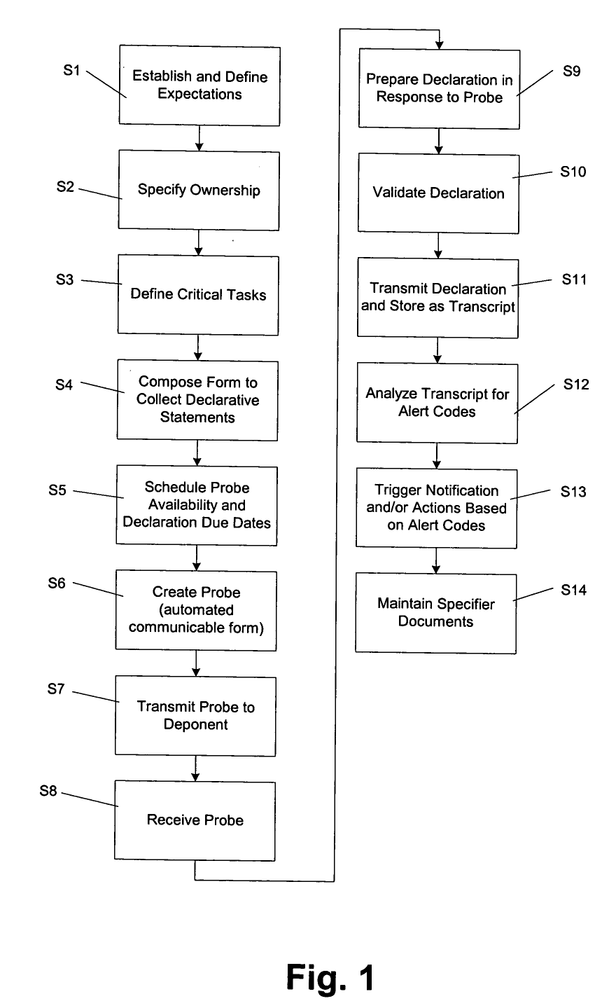

A system and method for documenting critical tasks and improving accountability according to the present invention will now be described with reference to FIGS. 1 to 3 of the accompanying drawings.

Organizations need an economical and reliable way to track the performance of certain tasks that are “critical” to the operation of facilities or processes. A task is considered “critical” when adverse consequences would result (or managers are concerned that such adverse consequences might result) if the task is performed late or poorly or not at all. Of course, the tracking of critical tasks may produce either negative or positive news for the organization.

Regrettably, these same managers are often held accountable for that unacceptable performance, even though they lack full control over key variables that drive the outcomes. This is a high-risk situation: The work environment is de-stabilized when senior people are counting on the manager, but the manager cannot fully count on the people who report to him.

Accountability is the result of people counting on one another to keep performance commitments and communication agreements. While accountability is a worthy goal, it can be challenging to implement, even in simple organizations. In complex work environments, the coordination of actions and expectations can be especially difficult.

The Applicants have developed technology described herein that can help people in complicated work environments. A tool is described herein that will reduce risk by facilitating social interdependence. The tool provides a new type of functionality called critical task management. The tool may incorporate its own electronic performance support system and data collection system, or it can be combined with existing electronic performance support systems, to provide local decision-makers with an unprecedented power to take action.

How would a computer system help people to count on each other? In general, simple organizations do not require high technology to manage the performance of critical tasks. However, not all organizations are simple. Some—especially those in industrial environments—may not do the important things well precisely because of accountability problems—even if all participants heartily endorse accountability in principle. It is often easy to spot those organizations that are well suited for the kind of technological assistance offered by the present invention. A few of the typical characteristics of such organizations are:
Expensive facilities that can be easily damaged.
Large numbers of employees in geographically-dispersed locations.
Intense scrutiny by regulatory agencies.
Potential for large-scale environmental damage.

Whatever the particulars of a specific situation, there are usually significant consequences for “dropping the ball” (i.e., for the unacceptable performance of critical tasks).

On a more personal level, accountability problems can develop in a variety of ways. For example:
Highly-trained workers may overlook problematic conditions when routine efforts become monotonous..
Social pressures may inhibit the candid reporting of unsatisfactory conditions.
Even well meaning workers may be unclear about how and when to communicate news of undesirable situations.

The Applicants believe that computer systems can help to coordinate crucial activities so that each participant delivers what others expect, or communicates that he has not done so. More specifically, the present invention provides an automated system and method for tracking and documenting the performance of critical tasks.

The root scenario for the method according to the present invention begins with a manager who needs to know the completion status of a critical task.
That person defines a Probe and sends it out to field personnel. The Probe contains sets of mutually-exclusive statements, all pertaining to various aspects of the task. A Probe can be updated easily, just by adding or excluding various statement sets.
A person who receives the Probe must select only one statement from each set. Since the statements are mutually-exclusive, their meanings are not likely to be ambiguous. Each selection is considered to be an Affirmation because it implies conviction based on evidence and personal experience.
All selected Affirmations taken together equal one completed Declaration about the assigned activities. This process of reviewing and endorsing statements resembles the giving of testimony in a legal deposition; therefore the term Deponent is used to describe someone who makes a signed Declaration..
The Declaration is saved as a Transcript which then becomes part of a permanent record. The presence of certain terms or symbols in the Transcript can automatically trigger predefined actions by humans and/or machines.
A Notification System ensures that other team members will be alerted when expectations are not met, either because scheduled Declarations have not been submitted, or because a status or condition requires management attention.
   Steps Taken in the Process of the Present Invention

FIG. 1 shows a series of method steps S1 to S14 that correspond to the following descriptive headings 1 to 14, respectively.

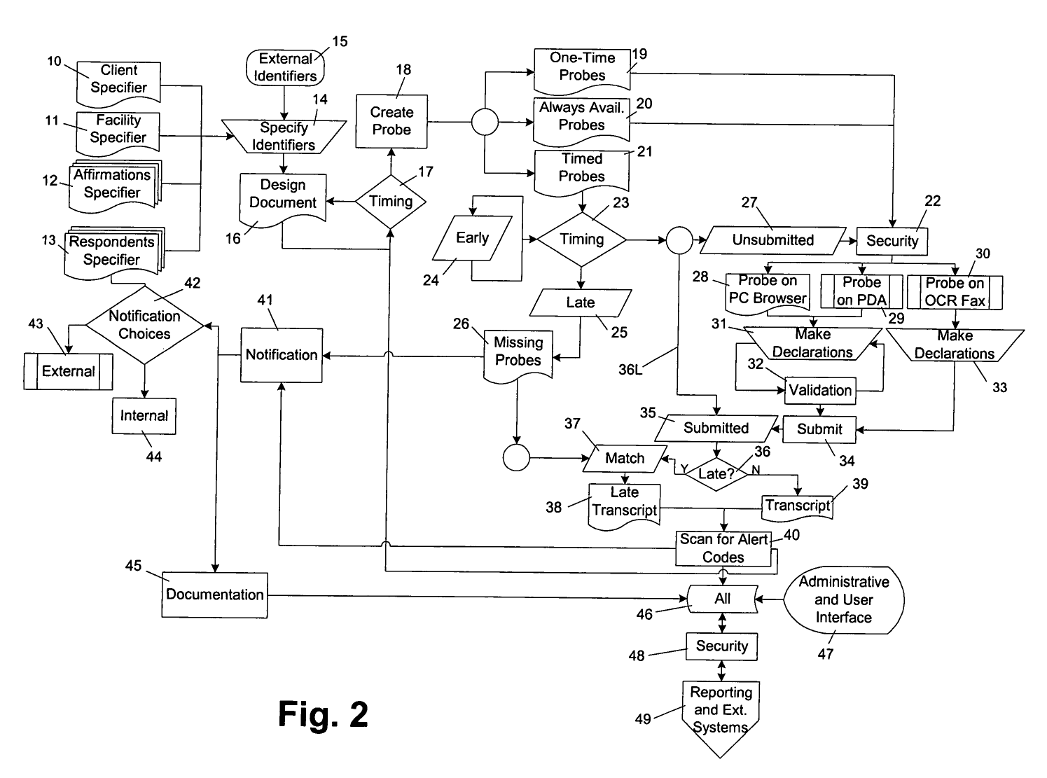

FIG. 2 shows a more detailed view of the process, as described and referenced below.

1. Establish and Define Expectations

The first requirement of this process is to set Operational Expectations. These Expectations are clearly understood and supported by all participants. The Outcomes are expressed both in terms of what needs to be accomplished and when the work product is due.

2. Specify Ownership

Next, documents are created that specify the client, the facility, and all parties who make up the chain of accountability. These documents are shown as the Client Specifier 10, the Facility Specifier 11, and the Respondents Specifier 13 in FIG. 2. The following items are recorded on these documents:
Name and owners of a given facility
Identity of those who will specify Critical Tasks
Identity of those who will carry out those tasks and comment on task status
Identity of those who will be notified in the event of an unresolved problem
   3. Define Critical Tasks

The present invention provides a tool for tracking and documenting the completion of Critical Tasks. The origins of Critical Tasks can be any or all of the following: regulatory (from governments at all different levels); corporate policy; contractual obligations; and communication with stakeholders. All of these sources have two items in common. First, they all focus on operational activities. Second, they all specify outcomes that are acceptable versus those that are not. The Critical Tasks are defined or specified by the Priority Coded Affirmations Specifier 12 in FIG. 2.

4. Compose a Form to Collect Declarative Statements and Associated Data

The four specifier boxes 10, 11, 12, and 13 in FIG. 2 are forms filled out in the application that cover all the information needed to manage the process. These four boxes 10-13 represent groups of information (i.e., sets of data) that will be used in the process. The Specify Identifiers box 14 is indicated as a manual input that receives information from the specifier boxes 10-13 plus another box labeled External Identifiers 15. The external identifiers input can be used to add additional specifiers automatically using, for example, an imported set of outside information used to automatically create more probes.

The next step is to create a form - something to collect the information that management needs. This form is a document that will be referred to herein as a Probe. It is developed by someone who wants detailed information about the performance of a critical task. This person is a Probe Creator, and he or she specifies all aspects of the exploration into a given activity.

The key word here is “specifies” because the software and computer system of the present invention actually does the work of form assembly. The Probe Creator determines what the form will contain by setting-up a design document 16 that brings together the various settings and affirmations from the manual input data collected at step 14. The design document 16 is then saved until a timer 17 indicates the availability time for the probe has been reached. Once the timer 17 indicates it is time for the probe to be available, the system reads these parameters and creates a Probe at step 18 that can be sent to a human respondent. For example, when an HTML code describing the requested parameters is assembled and put in the right spot, it is then referred to as a created probe.

The classic elements of Who, What, When, and Where are collected in any given Probe as follows:

Identifiers (Who and Where)

Name of the facility
Client name
Title of the probe
   Timing issues (When)
Appearance Type—One-Time Probes 19, Always-Available Probes 20, or Repeating or Timed Probes 21
Schedule, if Repeating—Daily, Weekly, Monthly, Quarterly, etc.
Times for making the Probe available, responding to it, and sending in Declarations
Note: Probes do not have to be scheduled. Some tasks may be more appropriately monitored on a continuously-available basis.
   Affirmation Sets (What)
General category
Specific item name
Mutually-exclusive affirmations for each item. Collectively, they encompass the complete range of acceptable responses. “I do not want to answer this question” is not an option.

Even though Affirmation sets always include at least one desirable and one undesirable statement, they are not simply pairs of yes-or-no questions, as they might appear in a typical survey. The Probe Recipient (or Deponent, as described below) must select one statement from each set that best characterizes a situation, result, or condition. Probes can also contain:
Comments Box
   Can be used by the Probe Recipient to communicate any information not addressed in the Affirmation sets
Authentication Box
   Captures the personal signatures of PDA users
Data Collection
   Fields to let users record numeric values, or incorporate photos, sounds, and so forth.
Branching Logic
   Display of special-purpose Affirmations and/or Questions, each contingent on user response patterns.
Hypertext Links to Other Web-Based Information
   Provides access to an extended information set, on an as-needed basis.
Existing Regulatory Forms
   Could be incorporated into a Probe on an item-by-item basis.
      5. Schedule Probe Availability and Declaration Due Dates

The Probe Creator specifies a “Time and Date Available” in the Design document 16. Once the designated time has arrived, the Applicants' system makes the Probe available for transmission. There are three types of probes: one-time use probes 19, always available probes 20, and timed probes 21. The one-time probes 19 and always available probes 20 are passed immediately to the security box 22. The timed probes 21, however, are passed to a timing box 23 and timing loop 24 and held as unsubmitted probes 27 until the designated time has arrived.

Each scheduled Probe also has an exact date and time when the completed information must be sent back to a server - again, most likely via synchronization. Due dates and times are also set by the Probe Creator.

6. Convert Settings and Choices to an Automated, Communicable Form

As soon as the Probe Creator saves his Design document, the software of the Applicants' invention processes all choices and immediately creates a Probe, as depicted by box 18 in FIG. 2. The result can be, for example, an HTML page with embedded JavaScript programming code or other suitable formatting for transmitting to the designated deponents.

The generated page (i.e., the Probe) can be opened by Internet web browsers in conventional PCs 28, Personal Digital Assistants (PDAs) 29, or any other two-way communication device, such as cell phones, laptops, pagers, OCR faxes 30, voice recognition devices, and so forth. Field personnel can then use the Probe form to record statements about the status of critical tasks, as explained below.

The Probe provides a communicable form that acts as a virtual deposition (or Deposition, for short). Individuals who respond to Probes are called Deponents. The word “deposition” is traditionally defined as sworn testimony taken from a witness before trial. As part of the pre-trial fact-finding process, Depositions are held out of court with no judge present. Clearly, this and other standard legal terms are used here in an unconventional manner. Nevertheless, the Applicants assert that a “real” deposition and a “virtual” deposition effectively yield the same results: Both are exercises in fact-finding.

The testimony in a Virtual Deposition is recorded verbatim, and can even include the Deponent's own handwritten signature (when recorded on mobile devices). The submitted Declaration is date-and-time stamped upon receipt, given a unique alphanumeric identifier, and protected from tampering. There is every reason to believe that the Transcript would be admissible in a court of law.

7. Transmit the Probe

Probe documents can be sent to Deponents in a variety of ways. The preferred and most-commonly-used method is to synchronize PDAs with specialized server software. This server processes standard web pages and makes them viewable on PDAs via Internet connections. Once this server determines the identity and authorization status of a synchronizing Deponent at the security checkpoint 22, the software of the present invention gathers the relevant Probes and transmits them over the Internet to the Deponent. The software can also be used to transmit Probes via other media, such as OCR fax, voice recognition and response technology, and so forth. For example, software can be integrated to send probes as a fax document and then receive them back using receiving fax software that decodes the fax and hands it back to the system again.

8. Receive the Probe

A single, targeted Deponent receives one or more Probes, most likely on a PC browser 28, a PDA 29, or an OCR fax 30. In some cases, Probes may be received on a computer that has been assigned to several users. For example, more than one person may have critical task responsibilities at a given facility. A database of the system of the present invention can accommodate multiple users, allowing the Probe to be received by someone other than the person who eventually responds to it.

9. Make Declarations

After receiving a Probe, the Deponent first reviews sets of mutually-exclusive statements, and then chooses one statement from each set. Each endorsed Affirmation represents the Deponent's most accurate understanding of that task or situation component.

If the Affirmation represents an undesirable condition, the software can immediately branch into an Electronic Performance Support System mode (EPSS). The Deponent can be provided with diagnostic assistance from an external source. This new information might help to solve problems at the closest point of contact. For example, if a Probe seeks information about a particular valve and the Deponent does not know where the valve is located, the EPSS can illustrate or provide additional information about the valve for the Deponent.

All selected Affirmations taken together comprise a finished Declaration about the assigned activities, as depicted by box 31 in FIG. 2. This Declaration document 31 distills much of what a Deponent knows about his tasks at a certain point in time. Before submitting a Declaration, the Deponent is required to sign it. If necessary, the Deponent can be instructed to sign his Declaration under oath, which would only increase the already considerable psychological involvement. Thus, the Probe Creator is not simply polling Deponents; he is asking them to attest.

10. Validate Declaration for Completeness

The Declaration made by the Deponent is validated for completeness at step 32. JavaScript or other suitable software can be embedded in the Probe itself to enhance data quality control. Declarations cannot be submitted unless an Affirmation has been selected from each set in the Probe. Additionally, the validation step 32 can be used to require Declarations on PC browsers 28 and PDAs 29 to be signed before they are submitted. Declarations 33 made by OCR fax 30 will generally be submitted directly without a validation step.

11. Transmit Declaration, then Store it as a Transcript in the Database

After any applicable validation, the declarations 31 and 33 are submitted at step 34 and become submitted declarations 35. Timing parameters are applied to the submission, as depicted by line 36L. The process then goes to a decision point to determine if the submission is on time or late. In practice, there may be several probes outstanding all the time and the system will be constantly looking for probes and declarations that are overdue. When the system receives a submitted declaration 35 that is overdue, the system will look to see if the corresponding probe has been declared as missing. If the system has already declared a probe as missing, the system will match the submitted declaration 35 with the missing probe, as indicated in the match box 37, and then create a late transcript 38. If the submitted declaration is on time, then a regular transcript 39 is created.

One important aspect of any Deposition is the recording of testimony. The transcripts 38, 39 generated from the submitted declarations 35 will provide a useful record of what the Deponent knows or observes about the critical tasks at a given point in time.

12. Assign ID Codes and Analyze for Key Content

The software of the Applicants' invention automatically assigns ID numbers to each Transcript, which correspond to ID numbers assigned to the design document and the Probe. The software then scans the contents of the Transcript for 5 certain flags that may act as triggers for other events. Each flag represents a noteworthy condition or variance that may be important to management. All departures from the norm are not equally significant, however: some might require nothing more than continued observation; while others might have catastrophic implications, and thus demand immediate action.

Not all news is bad, however. It would be just as possible to signal a happy turnaround after some long period of unsatisfactory outcomes. The same flagging system could be used in both welcome and unwelcome scenarios.

In the Applicants' invention, the importance of an issue is communicated with a specified number of flags or alert codes, such as the 1, 2, or 3 asterisks shown in the following examples.
1 flag on any individual Affirmation will cause the Transcript to be placed in a “Watched” or “Special Attention” area.
   Example: Data backup program DID NOT run as scheduled.*
2 flags on any given Affirmation will cause the software to notify Respondents via E-mail messaging. Respondents will certainly be managers, but might also include clients, and other interested parties designated by the client or by regulation.
   Example: Results from drug tests ARE available to unauthorized personnel.**
3 flags anywhere in the Transcript will cause the software to notify human Respondents via E-mail messaging and text paging.
   Example: The gas compressor is NOT on-line.***

The alert codes can be numbers or other special characters or codes other than asterisks, and more than three different alert codes can be used if desired. If the software finds the designated alert codes in step 40, the process goes to a notification box 41. The notification box 41 also receives information from the missing probes box 26. The particular form of notification is selected at the notification choices box 42 and can be either external notification 43 or internal notification 44. The notification choices 42 are made using the respondents specifier 13 during the manual data input at the beginning of the process. The external and internal notifications can be E-mail messages, text pager signals, buzzers, alarms, or various other types of notifications. Once the notifications are done, the notification is documented at step 45.

Action is not taken when a Transcript 38, 39 contains NO flags. Even if the Transcript 38, 39 contains no “unwanted news,” the document will still be retained. The Transcript 38, 39 has a value of its own as the record of a specific task that was completed on-time, and in accordance with expectations.

Additionally, notification is available for machine Respondents via XML and/or E-mail messaging. These alerts can themselves act as triggers for other software processes. For example, consider the role of an equipment manufacturer. This vendor might supply the database with important Affirmation sets related to particular models or lines of gear. If a customer's personnel send back Declarations that report on undesirable circumstances, the vendor's computer systems could be automatically notified. If those 5 systems were appropriately configured, parts might be automatically ordered, or other corrective actions might be coordinated by the manufacturer's engineers.

13. Test for Conformance with Expectations—Actions Taken

The transcript and documentation of any missing probes, declarations, or notifications are all stored in a database 46 as stored data. An administrative and user interface 47 allows authorized users to mine and use the stored data as necessary. Security systems 48 are used to limit access to the data. Reporting and external systems 49 can be used to archive the data at secure and preferably offsite locations for permanent storage and retrieval.

If expectations are met, information is soon archived and removed from the database 46; i.e., information about desired outcomes quickly loses immediate value to operations management. If expectations are not met, predesignated parties are notified, and/or machine-based tasks can be initiated.

In the broadest sense, management has two different types of expectations: 20 Some are related to Probe content as described above, and some are related to the Probe itself. The most important example of the latter type is that a Declaration will be sent back to the server on or before the due date and time.

Since time is such an important part of this tracking system, the software scans the database at frequent intervals to determine if expected Declarations have been saved as Transcripts. For example, suppose a Probe will be used to report the status of a control panel at Facility X. If a Transcript is expected by 4:00 P.M. on a certain day, the software will perform a database query at exactly that date and time. If the Transcript is missing for that specific Probe, a Placeholder document is created. This system-generated Placeholder announces to all parties that a scheduled event did not take place. Why the Probe did not yield a Transcript is usually not known when the Placeholder is created. Indeed, the only thing known is that a deadline has been missed.

If the expected Declaration is eventually submitted, the software will delete that Placeholder, and then stamp the newly-created Transcript as “Late.” Placeholder documents are only used for the missing results of scheduled probes. Not all monitored events are scheduled, however. Some Probes might be continuously available to field personnel. Transcripts from this type of Probe are not expected at any particular time, so no Placeholder is ever created to mark their absence.

14. Maintain Specifier documents

Part of the ongoing process is to maintain the Specifier documents 10-13. Specifiers contain background information that is essential to the tracking process. If the software discovers flags in a Transcript, Respondents need to be notified. The software looks up their E-mail addresses and pager numbers, as recorded in the Respondents Specifier documents 13.

Moreover, each facility belonging to a single organization may require that a unique set of Respondents be notified in the event of some variance. The Respondents Specifier documents 13 allow administrators to be precise about the conditions and targets of notification.

Specifiers have another important role: They control “who” can see “what” in the database. Suppose that 3 individuals work for a corporation: Senior Exec, as well as Managers 1 and 2. Senior Exec can see all documents in a database for his own company, while Managers 1 and 2 can only see those documents pertaining to their own operations. In other words, Manager 2 cannot see documents for operations reporting to Manager 1.

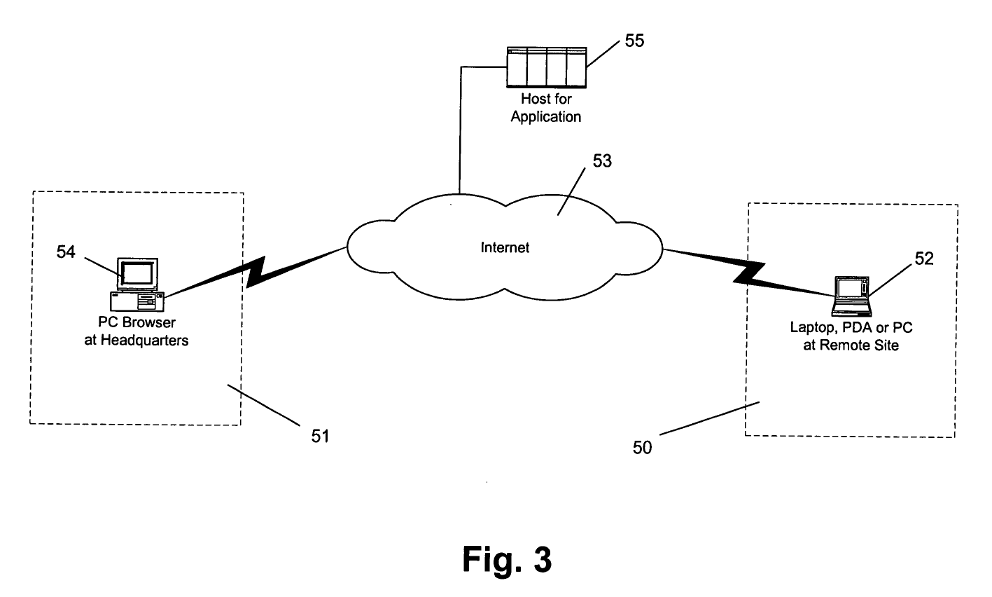

The basic features of the Applicants' invention have been described above with reference to FIGS. 1 and 2. An example of how the invention can be implemented in a specific industry will now be described with reference to FIG. 3.

As described above, the present invention provides a tool for tracking and documenting the completion of critical tasks by remote-based employees. An industry which is particularly suited for implementing the present invention is the energy industry, and particularly oil and gas production facilities, such as offshore oil platforms 50, having remote field personnel. The oil industry workers based on offshore oil platforms 50 can use the present invention to record the results of certain mandated inspections and the completion of certain critical tasks, which are often required by regulation or company policy. Such mandated inspections and critical tasks can be monitored and documented conveniently from the company headquarters 51 using the present invention.

Specifically, the employee of the offshore platform 50 can use an electronic device, such as a laptop or PDA 52, to communicate with the company headquarters 51 via the Internet 53 or other suitable communications network. The employee can use the laptop or PDA 52 to record his or her responses to a series of questions/probes. The specific content and parameters of the probes can be defined by company personnel at the headquarters 51 using a PC browser 54 connected to a host computer 55 via the Internet 53 or other suitable communications network. The probes are created by the software contained on the host computer 55 using the design criteria input through the PC browser 54. Alternatively, the software for creating the probes can be contained on the PC 54 and a direct communication network with the laptop or PDA 52 can be established without using the Internet.

The probe received by the laptop or PDA 52 will require declarative responses by the remote field personnel (e.g., I did observe an oil slick; I did not observe an oil slick). When the laptop or PDA 52 is synced with the server 55 containing the application software (either by wire or wirelessly), several actions are designed within the software program to respond to non-conforming answers. The software can automatically notify predetermined contacts with the supervisory group at the company headquarters 51 or other desired locations, by pager, phone or E-mail, of a non-conforming or undesirable response. The supervisory group can then operationally address non-conforming and undesirable responses. All answers (conforming and non-conforming) can be recorded utilizing a date/time stamp for documentation purposes.

The invention is targeted mainly at the energy industry, particularly oil fields, and more particularly offshore oil platforms. However, it will be appreciated that the invention can also be applied to various other industrial environments having critical tasks. For example, oil field publishing companies can use the invention to improve getting their insertion orders done on time.

While the invention has been specifically described in connection with specific embodiments thereof, it is to be understood that this is by way of illustration and not of limitation, and the scope of the appended claims should be construed as broadly as the prior art will permit.

1. A method of documenting critical tasks in a complex work environment, comprising the steps of:
creating a probe containing a set of mutually exclusive statements pertaining to a critical task;
transmitting the probe to field personnel;
receiving an input from field personnel corresponding to a selected one of the mutually exclusive statements; and
saving the input as a transcript that becomes part of a permanent record.

2. The method of documenting critical tasks according to claim 1, further comprising the steps of:
reviewing the transcript and determining whether certain alert codes are present in the transcript; and
automatically triggering predefined actions based on the presence of said alert codes in the transcript.

3. The method of documenting critical tasks according to claim 2, further comprising the steps of:
alerting other team members when expectations are not met, either because a scheduled input is not received from field personnel, or because a status or condition is detected that requires management attention.

4. The method of documenting critical tasks according to claim 1, wherein said probe contains a comments field for communicating information not addressed in the mutually exclusive statements.

5. The method of documenting critical tasks according to claim 1, wherein said probe contains an authentication field for capturing a personal signature of the field personnel.

6. The method of documenting critical tasks according to claim 1, wherein said probe contains a data collection field for recording numeric values, or incorporating photos or sounds.

7. The method of documenting critical tasks according to claim 1, wherein said probe includes a branching logic feature that displays special-purpose affirmations and/or questions contingent on user response patterns.

8. The method of documenting critical tasks according to claim 1, wherein said probe contains a hypertext link to other Internet-based information for providing access to an extended information set, on an as-needed basis.

9. The method of documenting critical tasks according to claim 1, wherein said probe incorporates an existing regulatory form on an item-by-item basis.

10. The method of documenting critical tasks according to claim 1, wherein said step of creating a probe comprises setting a time and date when the probe is made available for transmission.

11. The method of documenting critical tasks according to claim 1, wherein said step of creating a probe comprises setting a time and date when a completed response is due from the field personnel.

12. The method of documenting critical tasks according to claim 1, wherein the probe is transmitted by processing standard Internet pages and making them viewable on PDAs via Internet connections, and transmitting such Internet pages over the Internet to the field personnel.

13. The method of documenting critical tasks according to claim 1, further comprising the step of providing diagnostic assistance to the field personnel from an external source upon determining the existence of an undesirable condition.

14. The method of documenting critical tasks according to claim 1, wherein said probe contains a plurality of sets of mutually exclusive statements pertaining to various aspects of a critical task, and further comprising the step of compiling the inputs received from field personnel corresponding to said sets of mutually exclusive statements into a finished declaration about the critical task.

15. The method of documenting critical tasks according to claim 1, further comprising the step of scanning the content of the transcript for certain flags that represent a noteworthy condition or variance that may be important to management or act as a trigger for other events.

16. The method of documenting critical tasks according to claim 1, further comprising the step of preparing and maintaining specifier documents that contain information about who to notify when flags are discovered in the transcript, and information about who can access the transcript.

17. The method of documenting critical tasks according to claim 1, wherein said field personnel are located on an oil or gas production facility, and said critical task pertains to the maintenance and operation of said oil or gas production facility.

18. The method of documenting critical tasks according to claim 17, wherein said oil or gas production facility is an offshore oil platform.

19. A computer software program for documenting critical tasks in a complex work environment, comprising:
means for creating a probe containing a set of mutually exclusive statements pertaining to a critical task;
means for transmitting the probe to field personnel;
means for receiving an input from field personnel corresponding to a selected one of the mutually exclusive statements; and
means for saving the input as a transcript that becomes part of a permanent record.

20. The computer software program according to claim 19, further comprising:
means for reviewing the transcript and determining whether certain alert codes are present in the transcript; and
means for automatically triggering predefined actions based on the presence of said alert codes in the transcript.

21. The computer software program according to claim 19, wherein said means for creating a probe comprises a means for setting a time and date when the probe is made available for transmission and when a completed response is due from the field personnel.

22. The computer software program according to claim 19, wherein said probe contains a plurality of sets of mutually exclusive statements pertaining to various aspects of a critical task, and further comprising a means for compiling the inputs received from field personnel corresponding to said sets of mutually exclusive statements into a finished declaration about the critical task.

23. A system for documenting critical tasks in a complex work environment, comprising:
an input device for inputting design parameters of a probe for obtaining information about a critical task;
a computer that communicates with said input device and has a software program comprising:
means for creating a probe containing a set of mutually exclusive statements pertaining to a critical task based on input design parameters received from said input device;
means for transmitting the probe to field personnel;
means for receiving an input from field personnel corresponding to a selected one of the mutually exclusive statements; and
means for saving the input as a transcript that becomes part of a permanent record; and
a communications device for use by field personnel to receive the probe and to communicate information input by the field personnel back to the computer responsive to the probe.
